(19) United States
(12) Patent Application Publication
(10) Pub. No.: US 2026/0079810 A1
(43) Pub. Date: Mar. 19, 2026

(54) INTELLIGENT RESOURCE ALLOCATION USING SBOMS

(71) Applicant: Red Hat, Inc., Raleigh, NC (US)

(72) Inventors: Leigh Griffin, Waterford (IE); Leonardo Rossetti, Sao Paulo (BR)

(21) Appl. No.: 18/885,414

(22) Filed: Sep. 13, 2024

(51) Int. Cl. G06F 11/34; G06F 9/50

(52) U.S. Cl. CPC G06F 11/3428; G06F 9/5033

(57) ABSTRACT

Techniques for using the software bill of materials (SBOM) for each of a plurality of applications in a system to intelligently allocate resources of the system, are disclosed. The SBOM for each of a plurality of applications may be generated. The plurality of SBOMs is analyzed to identify common components among the plurality of applications, wherein a common component is a component that is common to two or more of the plurality of applications. For each common component, the location where the common component may optimally execute is identified and an SBOM that corresponds to the common component is updated to indicate the location where the common component may optimally execute.

### TECHNICAL FIELD

The present disclosure relates generally to optimizing resource allocation in computing systems for edge and automotive environments, and more particularly, to optimizing resource allocation based on common dependencies among applications deployed in such environments.

### BACKGROUND

An edge device is a device that provides an entry point into enterprise or service provider core networks. Examples of edge devices include assembly line tools, IoT gateways, points of sale, and industrial controllers. Edge devices can be hard to access or located in settings with little or no on-site technical expertise. Edge devices often operate with limited computing resources, power, cooling, and connectivity. This impacts their ability to efficiently manage multiple complex task queues that need to collect, process and respond to local data in a timely manner. This lack of resources can have negative consequences, especially in domains such as medical and automotive.

In addition, industries such as the automotive and aviation industries have a strong requirement for functional safety. Modern vehicles (e.g., automotive vehicles, marine vehicles, railed vehicles, aircraft vehicles, etc.) include computing systems that can execute one or more applications (e.g., software, computer code) to provide a variety of different critical services for managing the critical operations of the vehicle. For this reason, applications that execute on a vehicle's computing system are often classified as being either functional safety (FUSA) compliant or non-FUSA compliant (sometimes referred to as user application). An application that is classified as FUSA compliant is backed by a contractual agreement/engagement from a vendor of the application that the application will follow certain best practices/policies to ensure that the application behaves in a documented way and that such behavior will be consistent over time and consistent through changes to the code.

A software bill of materials (SBOM) is a document that provides a detailed inventory of the components and dependencies used in an application. A SBOM may list all of the libraries, frameworks, and their respective versions that are utilized within the application. The visibility provided by an SBOM can aid in understanding the application's composition, identifying potential vulnerabilities, and tracking compliance obligations associated with the application.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example system, according to some embodiments of the present disclosure.

FIG. 2 is a block diagram of a computing device illustrated in FIG. 1, illustrating generation of an SBOM for an application and identification of common components among applications, according to some embodiments of the present disclosure.

FIGS. 3A and 3B are detailed block diagrams of the computing device illustrated in FIG. 2, depicting the process of determining a location where a common component may optimally execute and updating SBOMs of applications that utilize the common component with the determined location, according to some embodiments of the present disclosure.

FIG. 4 is a flow diagram depicting a method of optimizing resource allocation based on common dependencies among applications, according to some embodiments of the present disclosure.

FIG. 5 is a block diagram of an example computing device that may perform one or more of the operations described herein, in accordance with some embodiments.

### DETAILED DESCRIPTION

Within any computing environment, having applications that share a similar profile from a dependency perspective can be wasteful resource-wise. This is particularly true when there are multiple variants of a single application (e.g., multiple different versions), which almost guarantees an overlap in component dependencies. This is problematic for edge networks, where resources constraints exist, and within the automotive context where it raises a risk of interference between applications which may cause FuSa infractions.

Aspects of the present disclosure address the above-noted and other deficiencies by generating a software bill of materials (SBOM) for each of a plurality of applications, thereby generating a plurality of SBOMs. The plurality of SBOMs is analyzed to identify common components among the plurality of applications, wherein a common component is a component that is common to two or more of the plurality of applications. The location where the common component may optimally execute is identified and an SBOM that corresponds to the common component is updated to indicate the location where the common component may optimally execute.

Embodiments of the present disclosure enable components (e.g., software dependencies, hardware dependencies and resource requirements) used by multiple applications (and/or by different versions of applications) to have a much smaller footprint, while also enabling updates to a single instance of a component to apply to other instances of the component used by other applications (and/or by different versions of the applications).

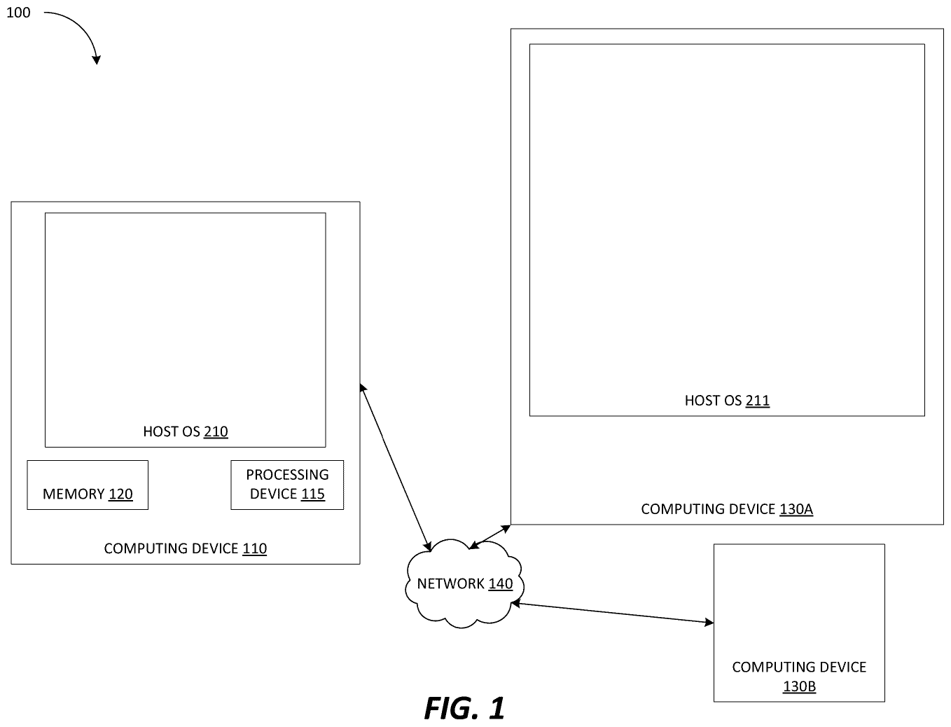

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110 and computing devices 130. The computing device 110 and each computing device 130 may include hardware such as processing device 115 (e.g., processors, central processing units (CPUs), memory 120 (e.g., random access memory (RAM), storage devices (e.g., hard-disk drive (HDD), solid-state drive (SSD), etc.)), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110.

Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as OS 210 and OS 211 of computing device 110 and 130A respectively, as discussed in more detail below. The OS of a computing device 110 and 130 may manage the execution of other components (e.g., software, applications, etc.) and/or may manage access to the hardware (e.g., processors, memory, storage devices etc.) of the computing device.

In some embodiments, the computing device 110 and the computing devices 130 may be edge devices where services are deployed natively (as opposed to using containers). Examples of edge devices may include assembly line tools, IoT gateways, points of sale, and industrial controllers. Edge devices often operate with limited resources (e.g., computing/CPU resources, storage/memory resources, power/battery resources, cooling resources, and network/connectivity resources among others). In some embodiments, the computing devices 110 and 130 may form a domain. A domain may include of a group of devices that share the same configuration, policies, and identity stores. The shared properties allow the devices within the domain to be aware of each other and operate together. The computing devices 130 may all be individual devices that are a part of a domain representing e.g., a fleet of internet of things (IoT) devices.

In other embodiments, the system 100 may be configured as a scalable, distributed computing system, such as a container orchestration platform. A container orchestration platform is a platform for developing and running containerized applications and may allow applications and the data centers that support them to expand from just a few machines and applications to thousands of machines that serve millions of clients. Container orchestration platforms may provide an image-based deployment module for creating containers and may store one or more image files for creating container instances. Many application instances can be running in containers on a single host without visibility into each other's processes, files, network, and so on. Each container may provide a single function (often called a “service” or “microservice”) or component of an application, such as a web server or a database, though containers can be used for arbitrary workloads. A microservices architecture is a cloud-native approach to building software in a way that allows for each core function within an application to exist independently and communicate through lightweight APIs. The container orchestration platform may scale a service in response to workloads by instantiating additional containers with service instances in response to an increase in the size of a workload being processed by the nodes. One example of a container orchestration platform in accordance with embodiments is the Red Hat™ OpenShift™ platform built around Kubernetes.

A typical deployment of a container orchestration platform may include a control plane (e.g., computing device 110) and a cluster of worker nodes, (e.g., computing devices 130). The worker nodes may run the aspects of the container orchestration platform that are needed to launch and manage containers, pods, and other objects. For example, a worker node may be a physical server that provides the processing capabilities required for running containers in the environment. A worker node may also be implemented as a virtual server, logical container, or GPU, for example.

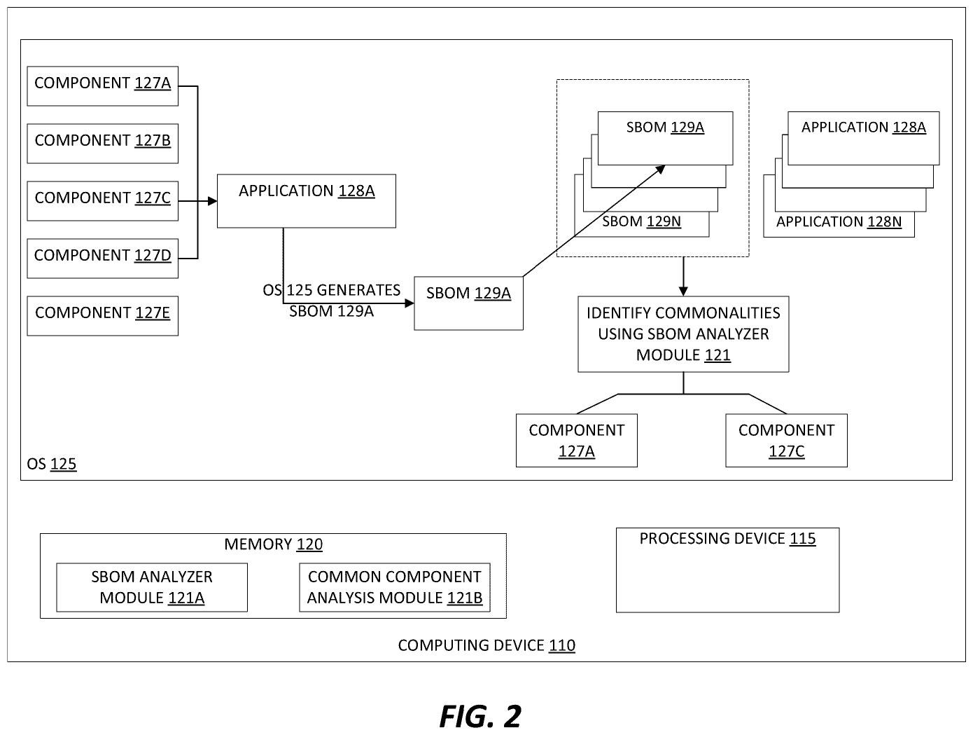

FIG. 2 illustrates the computing device 110 in accordance with some embodiments of the present disclosure. The OS 125 may host a number of components 127A-127E that may be used as building blocks when building an application. Each component 127 may comprise any appropriate application building block such as a software dependency (e.g., firmware, microservice, libraries, frameworks, and their respective versions), a resource requirement (e.g., an amount of free memory required to run, amount of network bandwidth needed to run etc.) or a hardware dependency (e.g., camera, certain type of processor). In the example of FIG. 2, the processing device 115 (executing functionality of the OS 125) may build application 128A using components 127A, 127C and 127D. During the process of building the application 128A, the processing device 115 may generate an SBOM 129A that provides a detailed inventory of the components 127 used in the application 128A. The processing device 115 may use any appropriate tool for generating SBOMs such as the jbom tool, for example.

Because SBOMs are a flat file construct, the SBOMs 129 generated by the processing device 115 may include sections for hardware dependencies, resource requirements and any other appropriate information regarding construction of the corresponding application 128. Although typically information regarding hardware dependencies and resource requirements would not be bundled from a separations of concerns perspective, doing so in an SBOM simply involves extending an XML/JSON/YAML file (the SBOM) and enumerating information about the hardware dependencies and resource requirements in a syntax that is understandable by the processing device 115, the SBOM analyzer module 121 and the common component analysis module 121B.

As can be seen in FIG. 2, the OS 125 may include a number of SBOMs 129 including SBOM 129A (e.g., one SBOM 129 for each application 128 it has built). The processing device 115 (executing the SBOM analyzer module 121) may analyze the SBOMs 129 to identify components 127 that are common between two or more of the corresponding applications 128 (hereinafter referred to as a common component). As used herein, a common component is a component 127 that is required by two or more of the applications 128. A common component may be e.g., a common software dependency, a common resource requirement (e.g., amount of free memory required to run), or a common hardware dependency (e.g., a camera).

The extent to which two components 127 from different applications must match to be identified as a common component among those applications may be configured by a user. The SBOM analyzer module 121 may be configured to require a certain level of matching for all components 127 or different levels of matching for different types of components 127. For example, a software dependency of SBOM 129A may be firmware with a version number of “1.3.4,” where the “1.3” corresponds to the base version number and the “4” corresponds to a patch number. Thus, if the SBOM analyzer module 121 is configured to require an exact match of the version numbers to identify a common component, when comparing the software dependency of SBOM 129A to a software dependency of SBOM 129B, the software dependency of SBOM 129B must also be the firmware with the version number of “1.3.4” for version number 1.3.4 of the firmware to be considered a common component (e.g., common software dependency) between the applications 128A and 128B corresponding to SBOM 129A and SBOM 129B respectively.

Alternatively, the SBOM analyzer module 121 may be configured to require only that the version numbers of the software dependency of SBOM 129A and the software dependency of SBOM 129B be within a threshold level of similarity to be matching. For example, the SBOM analyzer module 121 may be configured to require only that the base version numbers of the software dependency of SBOM 129A and the software dependency of SBOM 129B match. For example, if the software dependency of SBOM 129B has a version number starting with “1.3,” it will be considered as matching the software dependency of SBOM 129A. Even if the SBOM analyzer module 121 is configured to require a first level of matching between components of a first type (e.g., software dependency), it may still be configured to require a different level of matching between other types of components (e.g., resource requirements and hardware dependencies).

In scenarios where the SBOM analyzer module 121A is configured to require only a threshold level of similarity between two components 127 to identify them as a common component, the SBOM analyzer module 121A may include logic to determine which of the two components 127 should be used as the common component. For example, components 127B and 127D may correspond to different versions of a software dependency, with component 127B corresponding to version 1.3.4 of the dependency and component 127D corresponding to version 1.3.7 of the dependency. Because the SBOM analyzer module 121A is configured to ignore patch numbers when determining whether two software dependencies match, it may determine that components 127B and 127D are matching. The SBOM analyzer module 121A may utilize its logic to determine which component (127B or 127D) should be used as the common component in such scenarios. This logic may include a set of rules (not shown) for making such a determination.

For example, a first rule may specify that resource requirements (e.g., CPU requirements, available disk storage) of each version of the software dependency are the determining factor and thus that the component 127B or 127D that has fewer resource requirements may be selected as the commonality. Such a rule may assign weights to each resource type, so that a version that has lower requirements for heavily weighted resource types is selected over a version that has lower requirements for less weighted resource types. Another example rule may specify that decisions are to be made based on the lowest version available. For example, if components 127B and 127D are common among twenty of the applications 128, 19 of which use component 127C and only one of which uses component 127B, the processing device 115 may select component 127B as it corresponds to the lowest version available (i.e., version 1.3.4 of the software dependency as opposed to component 127D which corresponds to version 1.3.7 of the dependency). Another example rule may specify that the common component should correspond to a preset minimum version for backwards compatibility (that is based on e.g., a user/admin preference) or higher version. For example, a user may set version 1.3.7 of the software dependency as the minimum version of the software dependency the OS 125 will support. In this case, the processing device 115 may select component 127D as the commonality. This is important because edge and automotive environments often support every combination of versions from the minimum supported version onwards. Thus, in the example above (where component 127B corresponds to version 1.3.4 of the software dependency and component 127D corresponds to version 1.3.7 of the dependency), if version 1.3.4 of the software dependency were set as the minimum version of the software dependency the OS 125 will support, the processing device 115 would have to test a combinatorial matrix of 4 supported versions including versions 1.3.4, 1.3.5, 1.3.6, and 1.3.7.

The rules described above may be applied based on the type of component 127, for example a certain rule(s) may apply to certain types of components 127 while a different rule(s) may apply to other types of components 127. If multiple rules can be applied, the rules may have a hierarchy/order in which they are applied.

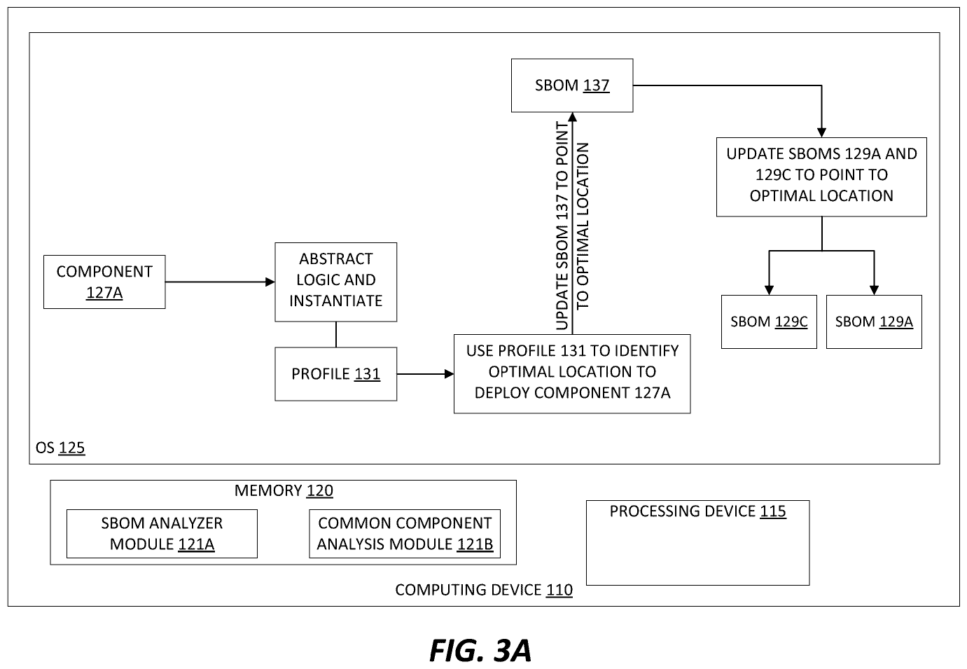

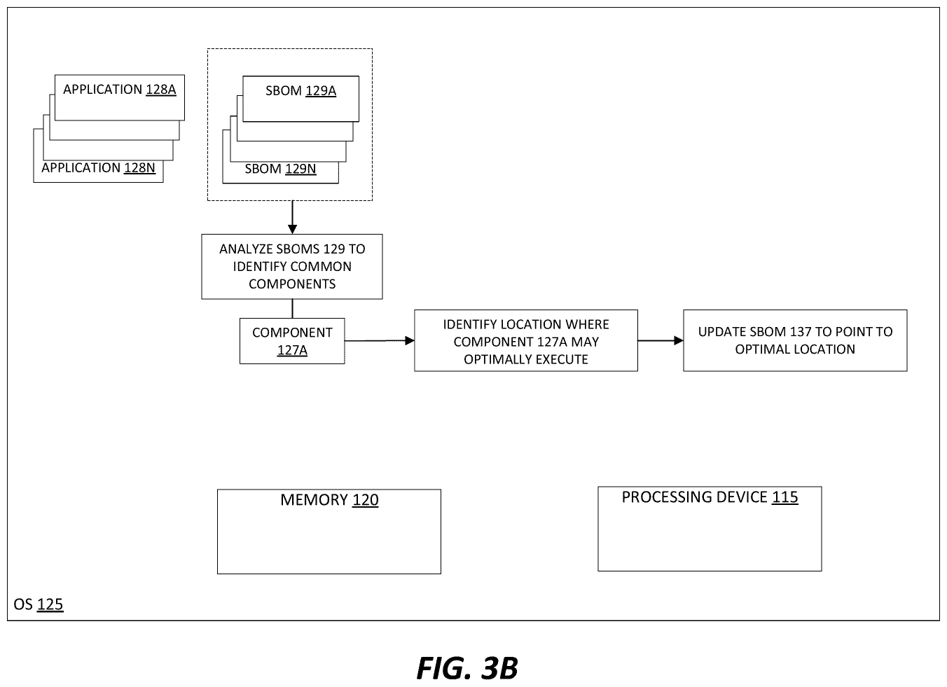

In the example of FIG. 2, upon analyzing the SBOMs 129, the OS 125 may identify components 127A and 127C as common components among the applications 128 (i.e., components 127A and 127C are both used by two or more of the applications 128). Upon identifying the common components, the processing device 115 may determine for each identified common component, the optimal location for the common component to execute. The optimal location may be e.g., one of the computing devices 110 or 130 (e.g., an IoT device or a server), a container/VM running thereon, or a particular processing device of any of the computing devices 110 or 130 that matches the requirements of the common component. FIGS. 3A and 3B continue the example of FIG. 2, and illustrate the process of identifying the optimal location for component 127A (identified as a common component in FIG. 2) to execute. In the example of FIGS. 3A and 3B, the component 127A may be a software dependency that is required by applications 128A and 128C. The processing device 115 (executing common component analysis module 121B) may abstract the logic of the component 127A and instantiate it, for example in a container. As a result of instantiating the component 127A, the component 127A may now have a profile 131 associated with it. The profile 131 may comprise a configuration file (not shown) including configuration data that can be deployed to a container. The configuration file may include a plurality of annotations that comprise benchmarking information identifying the resource requirements of the component 127A including e.g., the computing/CPU resource requirements, storage/memory resource requirements, disk I/O resource requirements, and networking/bandwidth resource requirements, among other resource requirements. This benchmarking information may allow for identification of the optimal location for the component 127A to execute. More specifically, based on the benchmarking information, the processing device 115 may select the optimal location for the component 127A to execute in a combinatorial manner to try to satisfy the resource requirements of the component 127A.

For example, if the component 127A requires 2 CPU cores, 4 GB of RAM and 2 GB of disk storage, the processing device 115 would try to avoid deploying the component 127A to a location that would be under provisioned and hence result in performance of the component 127A being degraded. If the performance of the component 127A suffers this could cause a stability issue and hence impact the applications 128A and 128C (e.g., FuSa applications) that depend on it. For example, applications 128A and 128C may freeze or experience latency issues. If the processing device 115 deploys the component 127A to a location that is over-provisioned, this may result in a waste of resources and increased costs associated with the expanded size of the instance of the component 127A. These costs could be monetary costs (e.g., cloud services costs), energy costs (e.g., battery life) or opportunity costs. Similarly, in a scenario where the components 127A and 127C depend on each other, the processing device 115 may deploy both components 127 to a single destination so that all calls between components 127A and 127C are internal instead of requiring network calls which would increase the networking/bandwidth requirement.

Thus, deployment of a component 127 to an optimal location represents a combinatorial optimization problem, where the processing device 115 may optimize for one or more of cost, computing/CPU resources, storage/memory resources, disk I/O resources, networking/bandwidth resources, and/or architectural efficiency. This optimization may be governed by a set of rules (not shown) included in the common components analysis module 121B to balance the system 100 as a whole, while also meeting the needs of individual components 127.

With respect to hardware dependencies, the processing device 115 may assume that the relevant hardware dependency (e.g., particular processing device, particular memory, particular peripheral device (e.g., camera)) is available and identify each instance of the device corresponding to the hardware dependency in the system 100. In addition, the processing device 115 may have access to the benchmarking information for each device corresponding to the hardware dependency without needing to instantiate them and may use the combinatorial approach described above in a similar manner to decide (based on the benchmarking information) which device corresponding to the hardware dependency is the optimal device for use with the corresponding applications 128. For example, each device corresponding to the hardware dependency may be evaluated based on e.g., number of network hops required (in a networking context) or number of disk storage reads required (in a memory/storage context).

Normally, an SBOM is created for an application 128 at the point in time when an application version's artifacts are created, resulting in an SBOM based on that version of an application 128. An application 128 is a collection of components 127 (e.g., microservices) and application versions are created when an underlying version of a component 127 is updated. However, SBOMs are produced at different levels of the software stack, including at the component level (as well as other levels) to provide tracking at the application level, the component level and other levels. This enables the OS 125 to have a complete audit trail of the entire supply chain used to create an application 128. Thus, the OS 125 may also include an SBOM 137, which may be an SBOM for the component 127A. A component level SBOM (e.g., SBOM 137) may include source code dependencies based on e.g., the programming language, packager, and SBOM tools used for the corresponding component. The SBOM 137 may be a child SBOM nested within a parent SBOM(s) (SBOMs 129A and 129C in this example).

Once the optimal location to execute component 127A has been determined, the processing device 115 may update the SBOM 137 to point to the optimal location. Because the SBOM 137 now points to the optimal location, it may be reused when any application 128 that depends on component 127A (e.g., applications 128A and 128C) wish to call the component 127A. When multiple applications 128 that depend on component 127A call it, they may all call the same instance executing in the optimal location, as opposed to each application calling its own instance of the component 127A. As a result, embodiments of the present disclosure enable common components (i.e., components 127 used in multiple applications 128 (and/or by different versions of applications 128)) to have a much smaller footprint, while also enabling updates to a single instance of the component 127 to apply to instances of the component 127 used by other applications 128 (and/or by different versions of the applications 128). In some embodiments, the processing device 115 may also update the (parent) SBOMs 129A and 129C (e.g., by extension of the SBOM 137 being updated) to point to the selected optimal location for execution of component 127A. This may enable the SBOMs 129A and 129C to be used for application-level tracking.

In addition, in the FuSa context, embodiments of the present disclosure help to prevent FuSa infractions. For example, FuSa applications or functionality may have a “FuSa flag,” to indicate they must be protected. This approach allows the processing device 115 to identify what components 127 (e.g., dependencies) might be invoking functionality that infringes the FuSa policies that govern those flagged applications. The processing device 115 may identify if, for example, a USB is plugged into a vehicle and a video streaming application is loaded and attempts to display video on the vehicle's main screen while the vehicle is in motion. The dependencies required in the SBOM for the video streaming application may include a main screen functionality component, which is also a dependency of a FuSa application. The FuSa application may be governed by a policy that prohibits display of video on the main screen while the vehicle is in motion. Thus, the processing device 115 may prevent either the main screen functionality component of the video streaming application from executing, or prevent the video streaming application from executing at all.

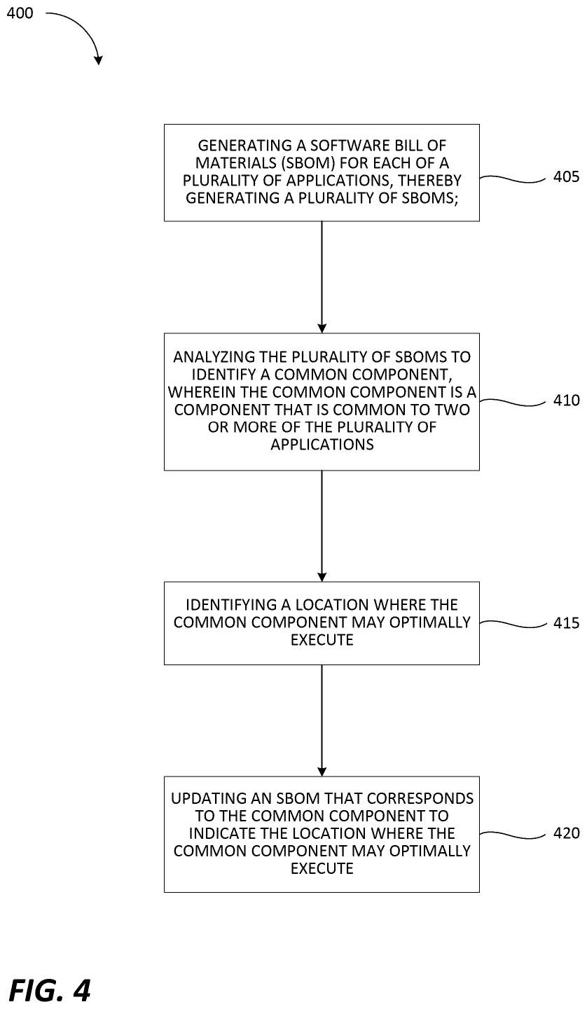

FIG. 4 illustrates a method 400 for intelligently deploying application components (e.g., microservices) to maximize resource usage in a system, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 illustrated in FIGS. 2 and 3).

Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring also to FIGS. 2, 3A and 3B, at block 405 the OS 125 may generate a number of SBOMs 129 including SBOM 129A (e.g., one SBOM 129 for each application 128 the OS 125 builds). At block 410, the processing device 115 (executing the SBOM analyzer module 121) may analyze the SBOMs 129 to identify components 127 that are common between two or more of the corresponding applications 128 (hereinafter referred to as a common component). As used herein, a common component is a component 127 that is required by two or more of the applications 128. A common component may be e.g., a common software dependency, a common resource requirement (e.g., amount of free memory required to run), or a common hardware dependency (e.g., a camera).

The extent to which two components 127 from different applications must match to be identified as a common component among those applications may be configured by a user. The SBOM analyzer module 121 may be configured to require a certain level of matching for all components 127 or different levels of matching for different types of components 127. For example, a software dependency of SBOM 129A may be firmware with a version number of “1.3.4,” where the “1.3” corresponds to the base version number and the “4” corresponds to a patch number. Thus, if the SBOM analyzer module 121 is configured to require an exact match of the version numbers to identify a common component, when comparing the software dependency of SBOM 129A to a software dependency of SBOM 129B, the software dependency of SBOM 129B must also be the firmware with the version number of “1.3.4” for version number 1.3.4 of the firmware to be considered a common component (e.g., common software dependency) between the applications 128A and 128B corresponding to SBOM 129A and SBOM 129B respectively.

Alternatively, the SBOM analyzer module 121 may be configured to require only that the version numbers of the software dependency of SBOM 129A and the software dependency of SBOM 129B be within a threshold level of similarity to be matching. For example, the SBOM analyzer module 121 may be configured to require only that the base version numbers of the software dependency of SBOM 129A and the software dependency of SBOM 129B match. For example, if the software dependency of SBOM 129B has a version number starting with “1.3,” it will be considered as matching the software dependency of SBOM 129A. Even if the SBOM analyzer module 121 is configured to require a first level of matching between components of a first type (e.g., software dependency), it may still be configured to require a different level of matching between other types of components (e.g., resource requirements and hardware dependencies).

In the example of FIG. 2, upon analyzing the SBOMs 129, the OS 125 may identify components 127A and 127C as common components among the applications 128 (i.e., components 127A and 127C are both used by two or more of the applications 128). At block 415, upon identifying the common components, the processing device 115 may determine for each identified common component, the optimal location for the common component to execute. The optimal location may be e.g., one of the computing devices 110 or 130 (e.g., an IoT device or a server), a container/VM running thereon, or a particular processing device of any of the computing devices 110 or 130 that matches the requirements of the common component. FIGS. 3A and 3B continue the example of FIG. 2 and illustrate the process of identifying the optimal location for component 127A (identified as a common component in FIG. 2) to execute. In the example of FIGS. 3A and 3B, the component 127A may be a software dependency that is required by applications 128A and 128C. The processing device 115 (executing common component analysis module 121B) may abstract the logic of the component 127A and instantiate it, for example in a container. As a result of instantiating the component 127A, the component 127A may now have a profile 131 associated with it. The profile 131 may comprise a configuration file (not shown) including configuration data that can be deployed to a container. The configuration file may include a plurality of annotations that comprise benchmarking information identifying the resource requirements of the component 127A including e.g., the computing/CPU resource requirements, storage/memory resource requirements, disk I/O resource requirements, and networking/bandwidth resource requirements, among other resource requirements. This benchmarking information may allow for identification of the optimal location for the component 127A to execute. More specifically, based on the benchmarking information, the processing device 115 may select the optimal location for the component 127A to execute in a combinatorial manner to try to satisfy the resource requirements of the component 127A.

For example, if the component 127A requires 2 CPU cores, 4 GB of RAM and 2 GB of disk storage, the processing device 115 would try to avoid deploying the component 127A to a location that would be under provisioned and hence result in performance of the component 127A being degraded. If the performance of the component 127A suffers this could cause a stability issue and hence impact the applications 128A and 128C (e.g., FuSa applications) that depend on it. For example, applications 128A and 128C may freeze or experience latency issues. If the processing device 115 deploys the component 127A to a location that is over-provisioned, this may result in a waste of resources and increased costs associated with the expanded size of the instance of the component 127A. These costs could be monetary costs (e.g., cloud services costs), energy costs (e.g., battery life) or opportunity costs. Similarly, in a scenario where the components 127A and 127C depend on each other, the processing device 115 may deploy both components 127 to a single destination so that all calls between components 127A and 127C are internal instead of requiring network calls which would increase the networking/bandwidth requirement.

Once the optimal location to execute component 127A has been determined, at block 420, the processing device 115 may update the SBOM 137 to point to the optimal location. Because the SBOM 137 now points to the optimal location, it may be reused when any application 128 that depends on component 127A (e.g., applications 128A and 128C) wish to call the component 127A. When multiple applications 128 that depend on component 127A call it, they may all call the same instance executing in the optimal location, as opposed to each application calling its own instance of the component 127A. As a result, embodiments of the present disclosure enable common components (i.e., components 127 used in multiple applications 128 (and/or by different versions of applications 128)) to have a much smaller footprint, while also enabling updates to a single instance of the component 127 to apply to instances of the component 127 used by other applications 128 (and/or by different versions of the applications 128). In some embodiments, the processing device 115 may also update the (parent) SBOMs 129A and 129C (e.g., by extension of the SBOM 137 being updated) to point to the selected optimal location for execution of component 127A. This may enable the SBOMs 129A and 129C to be used for application-level tracking.

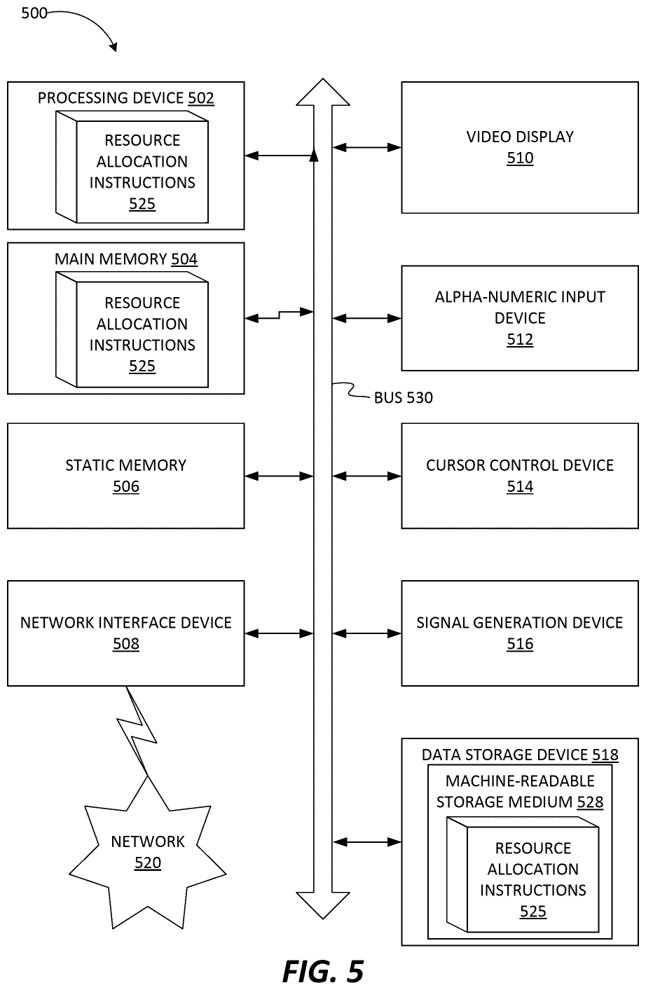

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a communication network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of resource allocation instructions 525 that may include instructions for one or more components, agents, and/or functions for carrying out the operations described herein, in accordance with one or more aspects of the present disclosure. The resource allocation instructions 525 may also reside, completely or at least partially, within main memory 504 and/or within processing device 502 during execution thereof by computing device 500, main memory 504 and processing device 502 also constituting computer-readable media. The resource allocation instructions 525 may further be transmitted or received over a communication network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “generating,” “analyzing,” “identifying,” “updating,” “instantiating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
generating a software bill of materials (SBOM) for each of a plurality of applications, thereby generating a plurality of SBOMs;
analyzing the plurality of SBOMs to identify a common component, wherein the common component is a component that is common to two or more of the plurality of applications;
identifying, by a processing device, a location where the common component may optimally execute; and
updating an SBOM that corresponds to the common component to indicate the location where the common component may optimally execute.

2. The method of claim 1, wherein the common component comprises a software dependency, a resource requirement or a hardware dependency.

3. The method of claim 1, wherein identifying the common component comprises:
identifying a first software dependency of a first application of the plurality of applications, the second software dependency having a first version number;
identifying a second software dependency of a second application of the plurality of applications, the second software dependency having a second version number;
comparing the first version number and the second version number to determine whether the first version number and the second version number are within a matching threshold; and
in response to determining that the first version number and the second version number are within the matching threshold, identifying the first software dependency and the second software dependency as matching components.

4. The method of claim 3, wherein identifying the common component further comprises:
identifying, based on a set of rules, the first software dependency or the second software dependency as the common component.

5. The method of claim 1, wherein identifying the location where the common component may optimally execute comprises:
instantiating the component to generate a profile comprising benchmarking information for the component; and
determining, based on the benchmarking information, the location where the common component may optimally execute.

6. The method of claim 5, wherein the benchmarking information comprises computing requirements, storage requirements, disk I/O requirements, and networking requirements of the common component.

7. The method of claim 6, wherein the location where the common component may optimally execute is determined combinatorially based on the benchmarking information.

8. A system comprising:
a memory; and
a processing device operatively coupled to the memory, the processing device to:
generate a software bill of materials (SBOM) for each of a plurality of applications, thereby generating a plurality of SBOMs;
analyze the plurality of SBOMs to identify a common component, wherein the common component is a component that is common to two or more of the plurality of applications;
identify a location where the common component may optimally execute; and
update an SBOM that corresponds to the common component to indicate the location where the common component may optimally execute.

9. The system of claim 8, wherein the common component comprises a software dependency, a resource requirement or a hardware dependency.

10. The system of claim 8, wherein to identify the common component, the processing device is to:
identify a first software dependency of a first application of the plurality of applications, the second software dependency having a first version number;
identify a second software dependency of a second application of the plurality of applications, the second software dependency having a second version number;
compare the first version number and the second version number to determine whether the first version number and the second version number are within a matching threshold; and
in response to determining that the first version number and the second version number are within the matching threshold, identify the first software dependency and the second software dependency as matching components.

11. The system of claim 10, wherein to identify the common component, the processing device is further to:
identify, based on a set of rules, the first software dependency or the second software dependency as the common component.

12. The system of claim 8, wherein to identify the location where the common component may optimally execute, the processing device is to:
instantiate the component to generate a profile comprising benchmarking information for the component; and
determine, based on the benchmarking information, the location where the common component may optimally execute.

13. The system of claim 12, wherein the benchmarking information comprises computing requirements, storage requirements, disk I/O requirements, and networking requirements of the common component.

14. The system of claim 13, wherein the processing device determines the location where the common component may optimally execute combinatorially based on the benchmarking information.

15. A non-transitory computer-readable medium having instructions stored thereon which, when executed by a processing device, cause the processing device to:
generate a software bill of materials (SBOM) for each of a plurality of applications, thereby generating a plurality of SBOMs;
analyze the plurality of SBOMs to identify a common component, wherein the common component is a component that is common to two or more of the plurality of applications;
identify, by the processing device, a location where the common component may optimally execute; and
update an SBOM that corresponds to the common component to indicate the location where the common component may optimally execute.

16. The non-transitory computer-readable medium of claim 15, wherein the common component comprises a software dependency, a resource requirement or a hardware dependency.

17. The non-transitory computer-readable medium of claim 15, wherein to identify the common component, the processing device is to:
identify a first software dependency of a first application of the plurality of applications, the second software dependency having a first version number;
identify a second software dependency of a second application of the plurality of applications, the second software dependency having a second version number;
compare the first version number and the second version number to determine whether the first version number and the second version number are within a matching threshold; and
in response to determining that the first version number and the second version number are within the matching threshold, identify the first software dependency and the second software dependency as matching components.

18. The non-transitory computer-readable medium of claim 17, wherein to identify the common component, the processing device is further to:
identify, based on a set of rules, the first software dependency or the second software dependency as the common component.

19. The non-transitory computer-readable medium of claim 15, wherein to identify the location where the common component may optimally execute, the processing device is to:
instantiate the component to generate a profile comprising benchmarking information for the component; and
determine, based on the benchmarking information, the location where the common component may optimally execute.

20. The non-transitory computer-readable medium of claim 19, wherein the benchmarking information comprises computing requirements, storage requirements, disk I/O requirements, and networking requirements of the common component.
